(19) United States
(12) Patent Application Publication
(10) Pub. No.: US 2013/0093359 A1
(43) Pub. Date: Apr. 18, 2013

(54) LIGHTING DEVICE

(71) Applicants: Po-Yi Hsu, Tainan City (TW); Chao-Chin Sung, Tainan City (TW)

(72) Inventors: Po-Yi Hsu, Tainan City (TW); Chao-Chin Sung, Tainan City (TW)

(73) Assignee: Econova Optronics Co., LTD., Tainan City (TW)

(21) Appl. No.: 13/355,480

(22) Filed: Jan. 20, 2012

(30) Foreign Application Priority Data
Oct. 12, 2011 (TW) 100137057

(51) Int. Cl. F21S 4/00; H05B 37/00

(52) U.S. Cl. 315/312; 362/223

(57) ABSTRACT

A lighting device includes a tube, an insulating body, a first circuit substrate and a plurality of first light emitting diodes. At least one portion of the tube is light-permeable. The insulating body is disposed in the tube, and has a first surface and a second surface which is opposite to the first surface. The first circuit substrate is disposed on the first surface. The first light emitting diodes are disposed on and electrically connected with the first circuit substrate.

### CROSS REFERENCE TO RELATED APPLICATIONS

This Non-provisional application claims priority under 35 U.S.C. §119(a) on Patent Application No(s). 100137057 filed in Taiwan, Republic of China on Oct. 12, 2011, the entire contents of which are hereby incorporated by reference.

### BACKGROUND OF THE INVENTION

1. Field of Invention

The present invention relates to a lighting device and, in particular, to a lighting device with light emitting diodes.

2. Related Art

The manufacturing processes and materials of light emitting diodes (LEDs) have been improved in the recent years, resulting in the sufficient enhancement of the luminance efficiency of LEDs. Superior to the conventional fluorescent lamps and compact lamps, the LED has the properties of lower power consumption, longer lifespan, higher security, shorter lighting response time, and smaller size. Accordingly, it is applied to many lighting device such as indoor lamp, flashlight, head light of vehicles, or other lighting devices.

FIG. 1A is an exploded view of a conventional LED lighting device 1, and FIG. 1B is a sectional view along line A-A of FIG. 1A.

As shown in FIGS. 1A and 1B, the lighting device 1 includes a tube 11, a plurality of LEDs 12, a circuit substrate 13, a heat-dissipating element 14, two electronic connecting elements 15, and a driving circuit 16.

The tube 11 has a long shape, and at least a portion of the tube 11 is made of light-permeable material. The LEDs 12 are located in the tube 11 and disposed on the circuit substrate 13. The circuit substrate 13 is disposed on the heat-dissipating element 14 and is electrically connected with the LEDs 12. The heat-dissipating element 14 is wedged to the tube 11. The electronic connecting elements 15 are disposed at two ends of the tube 11 and electrically connected with the circuit substrate 13. The driving circuit 16 is electrically connected with the circuit substrate 13 and the LEDs 12, and includes a circuit board 161 and a driving element 162 for driving the LEDs 12 to emit light. The circuit board 161 is connected to the lower surface of the circuit substrate 13. Accordingly, the heat generated by the LEDs 12 and the driving circuit 16 can be transferred to the heat-dissipating element 14 through the circuit substrate 13, and then dissipated by the heat-dissipating element 14.

In order to dissipate the heat generated by the LEDs 12, the heat-dissipating element 14 of the lighting device 1 is usually made of a metal with good heat conductivity (e.g. aluminum). Furthermore, the size of the heat-dissipating element 14 is usually very large to achieve the desired heat-dissipating effect. This feature largely increases the weight of the lighting device 1. Due to the affect of gravity or earthquake, the connection between the lighting device 1 and the lamp B may become non-firmed, so that the lighting device 1 may fall from the lamp B.

The circuit board 161 of the driving circuit 16 is disposed on the lower surface of the circuit substrate 13. Accordingly, an insulating layer (e.g. an insulating sheet) is needed between the circuit board 161 and the metal circuit substrate 13 for preventing the short circuit therebetween. However, after the lighting device 1 has been used for a long term, the insulating layer between the circuit board 161 and the circuit substrate 13 may be degraded, which results in the malfunction of the lighting device 1.

Therefore, it is an important subject of the present invention to provide a lighting device that has the advantages of light weight and good insulation property.

### SUMMARY OF THE INVENTION

In view of the foregoing subject, an object of the present invention is to provide a lighting device that has the advantages of light weight and good insulation property.

To achieve the above object, the present invention discloses a lighting device including a tube, an insulating body, a first circuit substrate and a plurality of first light emitting diodes. At least one portion of the tube is light-permeable. The insulating body is disposed in the tube, and has a first surface and a second surface which is opposite to the first surface. The first circuit substrate is disposed on the first surface. The first light emitting diodes are disposed on and electrically connected with the first circuit substrate.

In one embodiment, the heat transfer coefficient of the insulating body is between 1 and 20 W/mK.

In one embodiment, the insulating body is a heat-conductive plastic plate.

In one embodiment, the insulating body includes a polymer material.

In one embodiment, the first circuit substrate is a metal substrate.

In one embodiment, the insulating body and the tube are connected by wedging, adhering, screwing, locking, or thermal fusing.

In one embodiment, the area of the insulating body is larger than that of the first circuit substrate.

In one embodiment, the lighting device further includes a reflective layer or a light-shielding layer disposed on the first surface and surrounding the first circuit board.

In one embodiment, the lighting device further includes a first driving module, and the first driving module includes a circuit board and at least a driving element disposed on the circuit board.

In one embodiment, the first driving module is connected to the first surface or the second surface of the insulating body.

In one embodiment, the lighting device further includes two electronic connecting elements disposed at two ends of the tube.

In one embodiment, the lighting device further includes an optical structure disposed on the tube.

In one embodiment, the lighting device further includes a second circuit and a plurality of second light emitting diodes. The second circuit substrate is disposed on the second surface. The second light emitting diodes are disposed on and electrically connected with the second circuit substrate.

In one embodiment, the lighting device further includes a second driving module connecting to the first surface or the second surface of the insulating body.

In one embodiment, the first driving module and/or the second driving module are disposed at the outside of the tube.

As mentioned above, in the lighting device of the invention, the LEDs are disposed on the circuit substrate and the circuit substrate is disposed on the insulating body. Since the circuit substrate is smaller and lighter, and the lighter insulating body is configured, the weight of the lighting device of the present invention can be sufficiently decreased. In addition, due to the configuration of the insulating body, the lighting device can still have good insulation property without the conventional insulating layer. Moreover, the lighting device of the present invention can select the heat transfer coefficient of the insulating body according to the heat generated by the LEDs. For example, if the LEDs generate heat normally, the insulating body can be made of a material with low heat transfer coefficient. Otherwise, if the LEDs generate extremely large heat, the insulating body can be made of a material with higher heat transfer coefficient.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is an exploded view of a conventional LED lighting device;

FIG. 1B is a sectional view along line A-A of FIG. 1A;

FIG. 2A is an exploded view of a lighting device according to a preferred embodiment of the present invention;

FIG. 2B is a sectional view along line C-C of FIG. 2A;

FIG. 2C and FIG. 2D are schematic diagrams showing other arrangement aspects of the first LEDs;

FIGS. 2E to 2H are schematic diagrams showing other aspects of the lighting device of the present invention;

FIG. 3A is an exploded view of a lighting device according to another preferred embodiment of the present invention;

FIG. 3B is a sectional view along line D-D of FIG. 3A; and

FIG. 3C is a sectional view of a lighting device according to another preferred embodiment of the present invention.

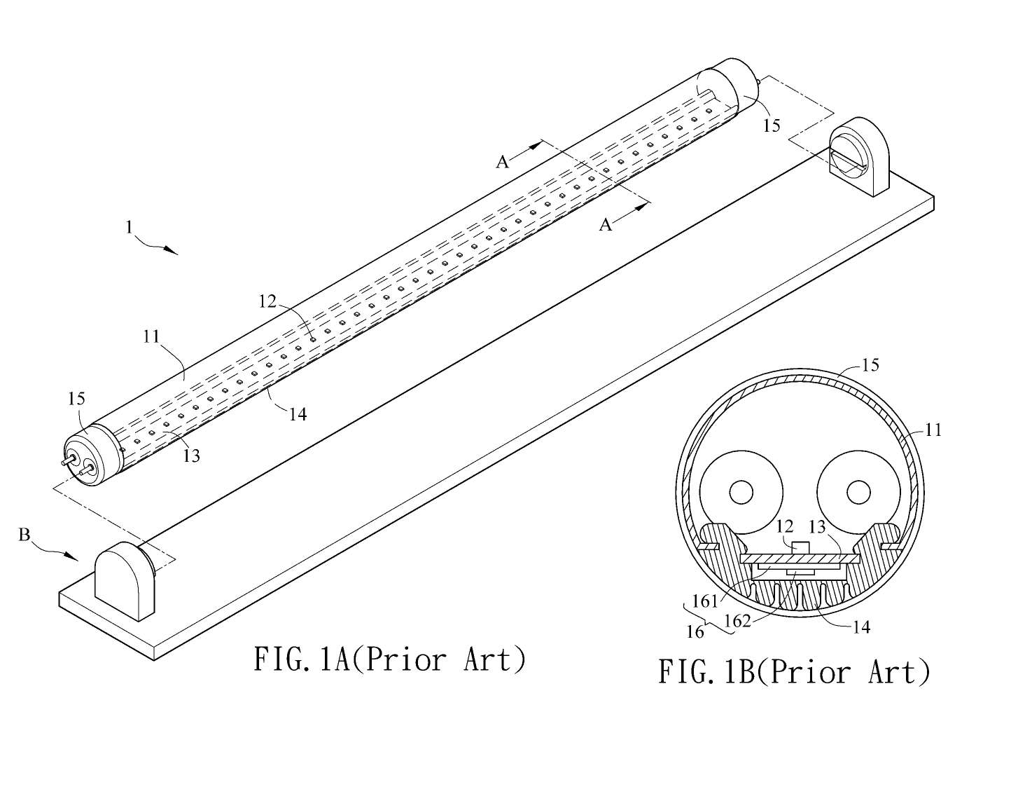

### DETAILED DESCRIPTION OF THE INVENTION

The present invention will be apparent from the following detailed description, which proceeds with reference to the accompanying drawings, wherein the same references relate to the same elements.

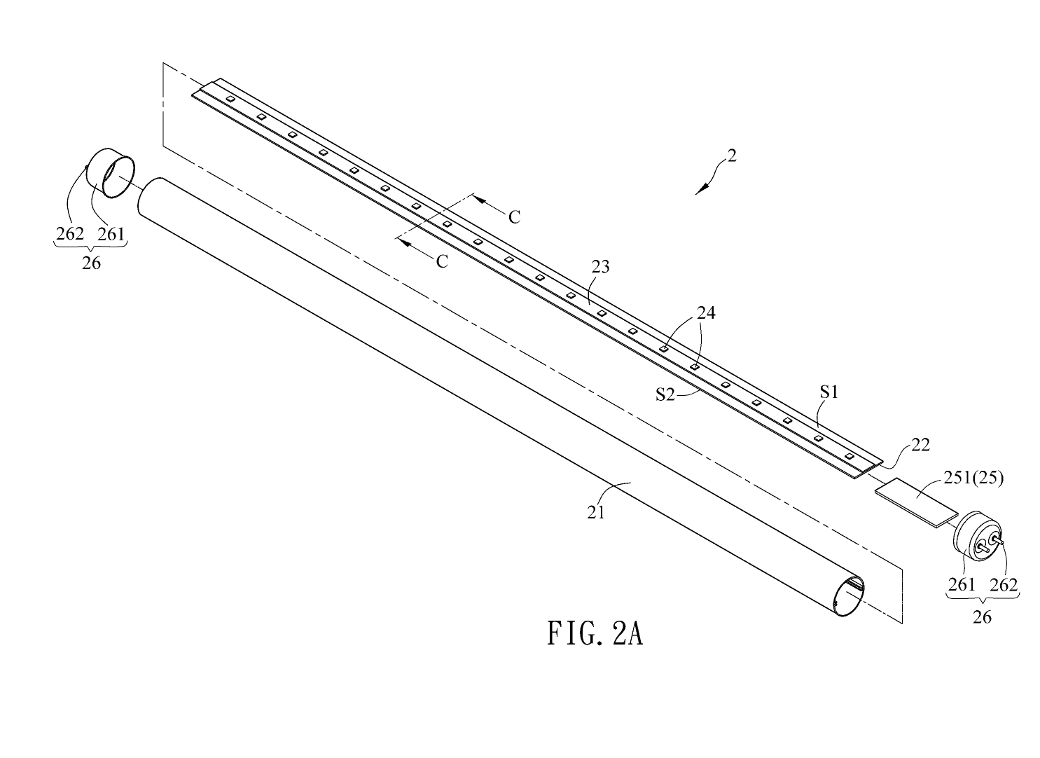

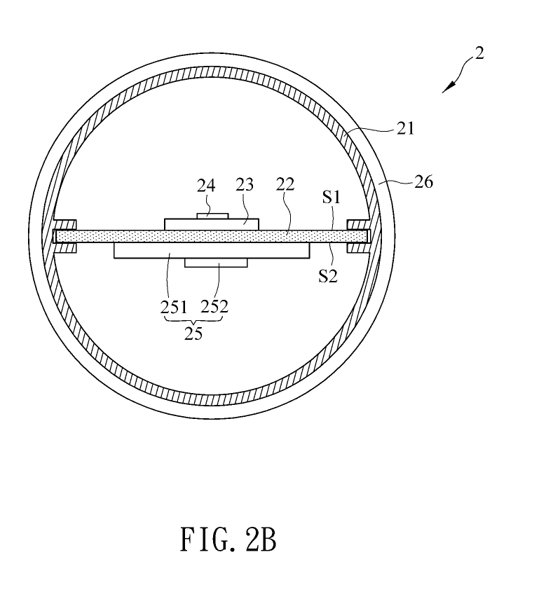

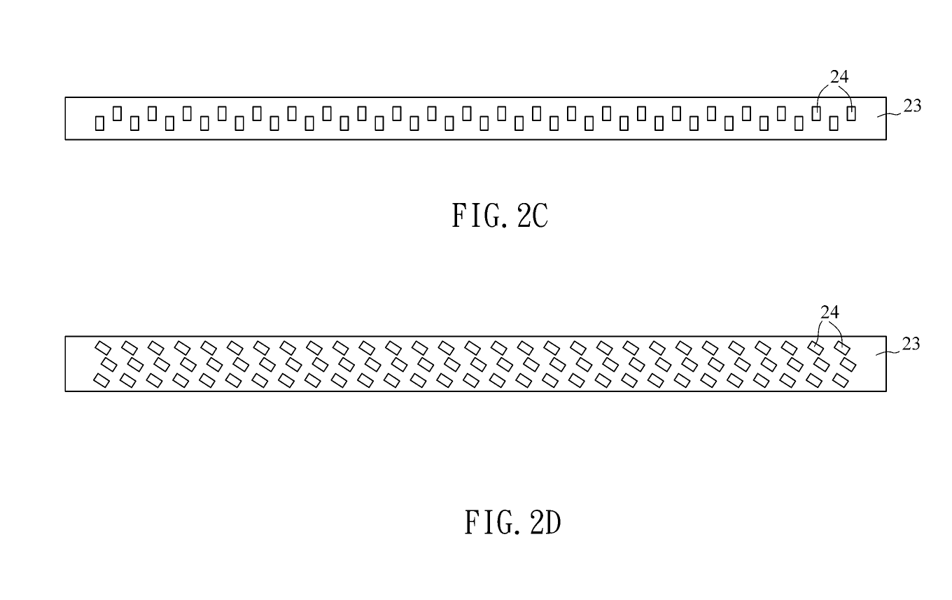

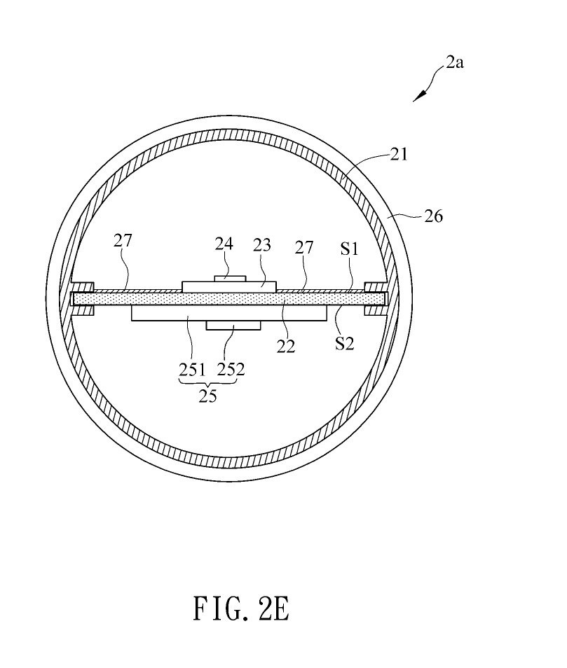

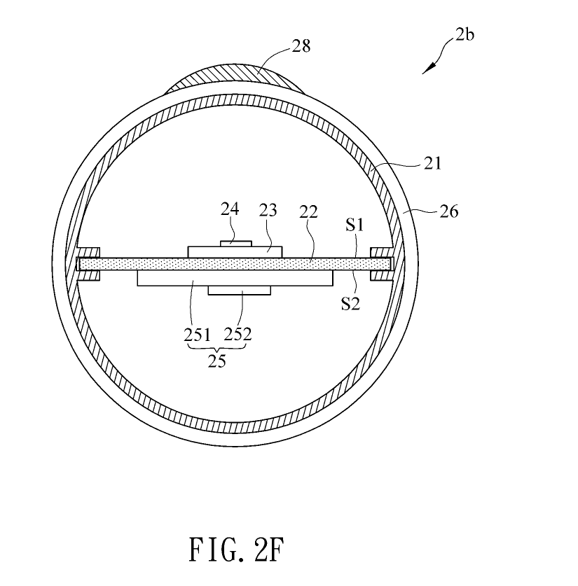

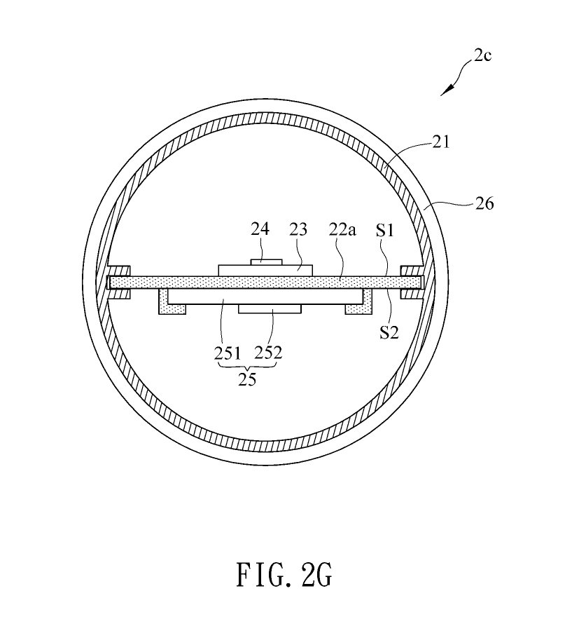

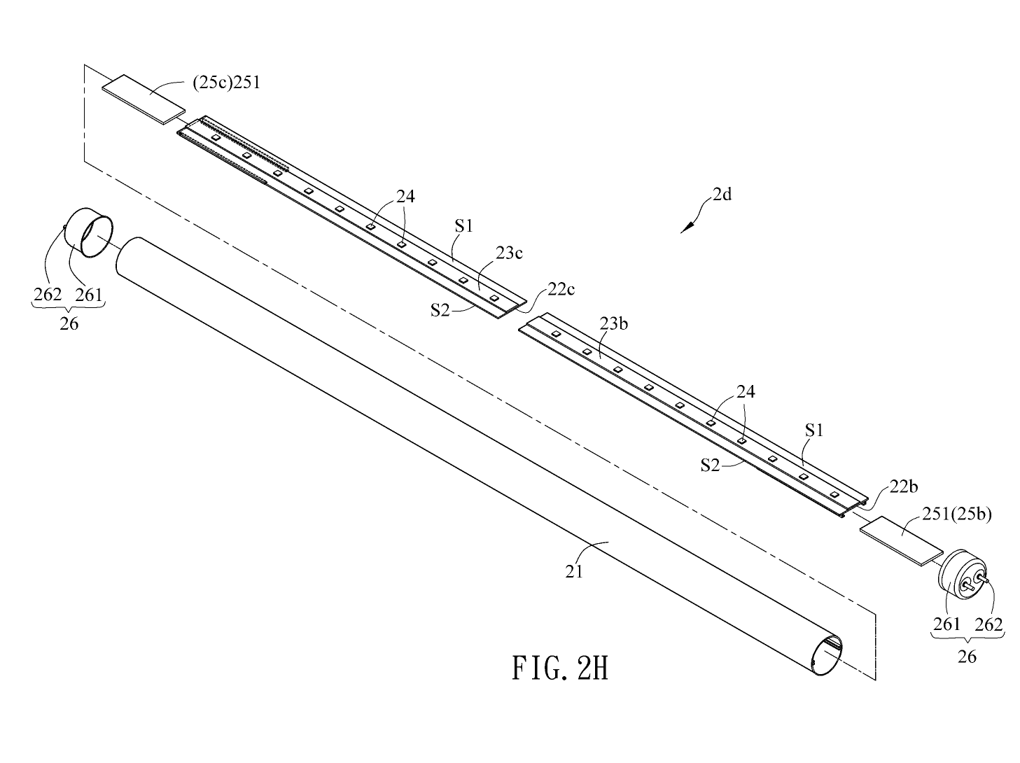

FIG. 2A is an exploded view of a lighting device 2 according to a preferred embodiment of the present invention, and FIG. 2B is a sectional view along line C-C of FIG. 2A. The lighting device 2 of the present invention can be used to substitute the conventional fluorescent lamp. If the lighting device 2 is installed on the conventional lamp holder, the starter is removed. Moreover, the electronic ballast can be also removed so as to further decrease the power consumption.

The lighting device 2 includes a tube 21, an insulating body 22, a first circuit substrate 23 and a plurality of first light emitting diodes (LEDs) 24. The insulating body 22 is disposed in the tube 21, and has a first surface S1 and a second surface S2 which is opposite to the first surface S1. The first circuit substrate 23 is disposed on the first surface S1 of the insulating body 22. The first LEDs 24 are disposed on the first circuit substrate 23. The tube 21 is substantially electronic insulation, and at least one portion of the tube 21 is light-permeable. The material of the tube 21 can be, for example but not limited to, plastic or glass. In this embodiment, the top half portion of the tube 21 is light-permeable, so that the light can be emitted from the top half portion of the tube 21. Of course, the tube 21 may be totally light-permeable. In addition, the cross-section of the tube 21 shows a closed curve, which has a start point and a destination point located at the same point. The shape of the cross-section can be circular, elliptic, square, rectangular or polygonal. In this case, the cross-section of the tube 21 is circular, and the material thereof is plastic material. Besides, the tube 21 can be integrally formed as one piece, or composed of multiple sub-portions connected by thermal fusion. In this embodiment, the tube 21 is integrally formed as one piece by injection molding or pressing molding. In addition, the light-output side of the tube 21 can have a surface mist treatment so as to soft and diffuse the light beam.

The insulating body 22 and the tube 21 are connected by, for example, wedging, adhering, screwing, locking, or thermal fusing. Of course, in other aspects, the insulating body 22 and the tube 21 can be connected by any other proper method. In this embodiment, the insulating body 22 is made of non-metal material such as polymer material (e.g. plastic, rubber, or chemical fiber).

The insulating body 22 can be made of the material with different heat transfer coefficients depending on the actual need. In this embodiment, the heat transfer coefficient of the insulating body 22 is between 0.1 and 20 W/mK. For example, if the first LEDs 24 generate heat normally, the insulating body 22 can be made of a normal insulating material (with lower heat transfer coefficient of 0.1˜1 W/mK). Otherwise, if the first LEDs 24 generate extremely large heat (e.g. the over-driving of the LEDs may generate large heat), the insulating body 22 can be made of a material with higher heat transfer coefficient of 1˜20 W/mK.

The insulating body 22 with higher heat transfer coefficient is, for example but not limited to, a thermal plastic plate. Herein, the thermal plastic material is mainly composed of engineering plastic and general plastic (e.g. PP, ABS, PC, PA, LCP, PPS or PEEK), and is doped with metal oxide powder, carbon, fiber or ceramic powder. For example, a typical insulating thermal plastic can be formed by mixing PPS with large magnesium oxide particles. The heat transfer coefficient thereof is typically ranged from 1 to 20 W/m-K, which is 5 to 100 times of the conventional plastic materials.

The first circuit substrate 23 is disposed on the first surface S1 of the insulating body 22. In this embodiment, the first circuit substrate 23 is a metal substrate (e.g. an aluminum substrate), and the area of the insulating body 22 is larger than that of the first circuit substrate 23. Since the insulating body 22 has the insulation property, the additional insulating layer between the first circuit substrate 23 and the insulating body 22 is unnecessary. The feature can prevent the problem caused by the degradation of the conventional insulating layer.

The first LEDs 24 are disposed on and electrically connected with the first circuit substrate 23. To be noted, the number and arrangement of the first LEDs 24 are not limited. In this embodiment, the first LEDs 24 are arranged linearly on the first circuit substrate 23 for example. Of course, the first LEDs 24 can also be arranged in a two dimensional array or other arrangements on the first circuit substrate 23. For example, the first LEDs 24 can be arranged on the first circuit substrate 23 regularly as shown in FIG. 2C, or be arranged irregularly as shown in FIG. 2D.

In this embodiment, the lighting device 2 further includes a first driving module 25, which includes a circuit board 251 and at least one driving element 252. The driving element 252 is disposed on the circuit board 251. The first driving module 25 is electrically connected to the first circuit substrate 23 for driving the first LEDs 24 to emit light. In this case, the circuit board 251 of the first driving module 25 is connected to the second surface S2 of the insulating body 22 by adhering. Of course, they can be connected by other method such as wedging, screwing or locking Since the insulating body 22 is made of insulating material, the additional insulating material between the first driving module 25 and the second surface S2 is unnecessary. In other words, the circuit board 251 of the first driving module 25 can be directly connected to the second surface S2 of the insulating body 22. This feature can prevent the problem caused by the degradation of the conventional insulating layer. Besides, the circuit board 251 of the first driving module 25 may be connected to the first surface 51 of the insulating body 22 depending on the actual needs (not shown in FIGS. 2A and 2B). In other aspects, the first driving module 25 may not be connected to the first surface 51 or the second surface S2 of the insulating body 22, but be disposed on other position. For example, the first driving module 25 can be disposed at the outside of the tube 21, and be electrically connected to the first circuit substrate 23 through a wire (not shown).

Moreover, the lighting device 2 may further include two electronic connecting elements 26 disposed at the tube 21 and electrically connected with the first driving module 25. In this embodiment, the two electronic connecting elements 26 are disposed at two ends of the tube 21, respectively, and seal the tube 21. Each electronic connecting element 26 includes a lamp cap 261 and two electrode connectors 262, which are fastened on the lamp cap 261. The lamp cap 261 is tightly connected to the tube 21 by, for example but not limited to, adhering, locking, screwing or thermal fusing. Since the cross-section of the tube 21 represents a closed curve, and electronic connecting elements 26 seal the tube 21, the lighting device 2 can have excellent electronic insulation and airtight property.

In other aspects, the two electronic connecting elements 26 may be disposed at the same end of the tube 21.

Referring to FIG. 2E, a lighting device 2a further includes a reflective layer 27 or a light-shielding layer (not shown). The reflective layer 27 or light-shielding layer is disposed on the first surface S1 and surrounds the first circuit board 23. This configuration allows the reflective layer 27 or light-shielding layer to reflect or shield the light emitted from the first LEDs 24. In this embodiment, a reflective layer 27 is provided. Herein, the reflective layer 27 or light-shielding layer is disposed on the first surface S1 by adhering. Otherwise, it is possible to coat the reflective material or light-shielding material on the first surface S1 so as to form the desired reflective layer 27 or light-shielding layer.

Referring to FIG. 2F, a lighting device 2b further includes an optical structure 28 disposed on the tube 21. In this case, the optical structure 28 is disposed at the light-output side on the tube 21. Of course, the optical structure 28 can be disposed on the inner surface of the light-output side of the tube 21 or be integrally formed with the tube 21. In this embodiment, the optical structure 28 is a lens, a prism or a reflective mirror, or includes microstructures to provide the desired function of concentrate or disperse the light.

FIG. 2G is a sectional view of another aspect of a lighting device 2c.

The difference between the lighting device 2c of FIG. 2G and the lighting device 2 of FIG. 2B is in that the circuit board 251 of the first driving module 25 is disposed on the second surface S2 of the insulating body 22a. Besides, the second surface S2 of the insulating body 22a has many receive portions for connecting the circuit board 251 to the insulating body 22a.

The technical features of other components in the lighting devices 2a, 2b and 2c are the same as those of the lighting device 2, so the detailed descriptions thereof will be omitted.

FIG. 2H is an exploded view of another aspect of a lighting device 2d.

The difference between the lighting device 2d of FIG. 2H and the lighting device 2c of FIG. 2G is in that the lighting device 2d includes two insulating bodies 22b and 22c, two first circuit substrates 23b and 23c, and two first driving modules 25b and 25c. In other words, the first driving module 25b is electrically connected with the first circuit substrate 23b for driving the first LEDs 24 disposed on the first circuit substrate 23b to emit light. The first driving module 25c is electrically connected with the first circuit substrate 23c for driving the first LEDs 24 disposed on the first circuit substrate 23c to emit light. The insulating body 22b can dissipate the heat generated by the first LEDs 24 disposed on the first circuit substrate 23b, and the insulating body 22c can dissipate the heat generated by the first LEDs 24 disposed on the first circuit substrate 23c. Of course, in other aspects, the two first driving modules 25b and 25c can be integrated as a single driving module, which can drive the first LEDs 24 disposed on both or either one of the first circuit substrates 23b and 23c to emit light.

The technical features of other components in the lighting device 2d are the same as those of the lighting device 2c, so the detailed descriptions thereof will be omitted.

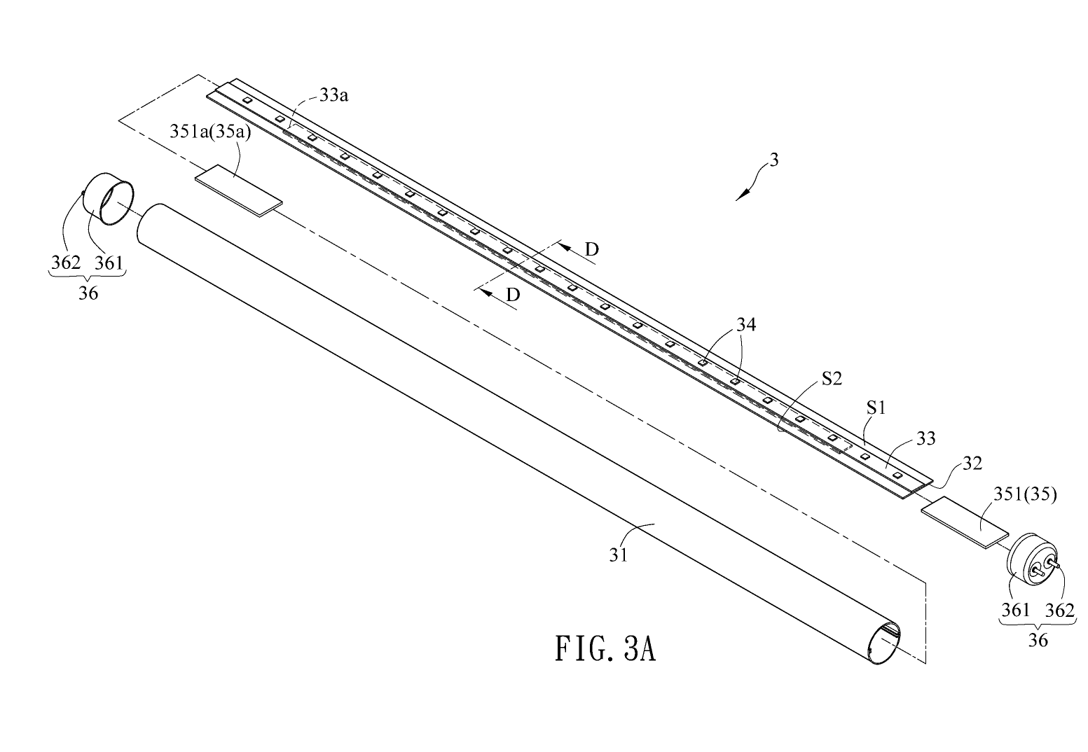

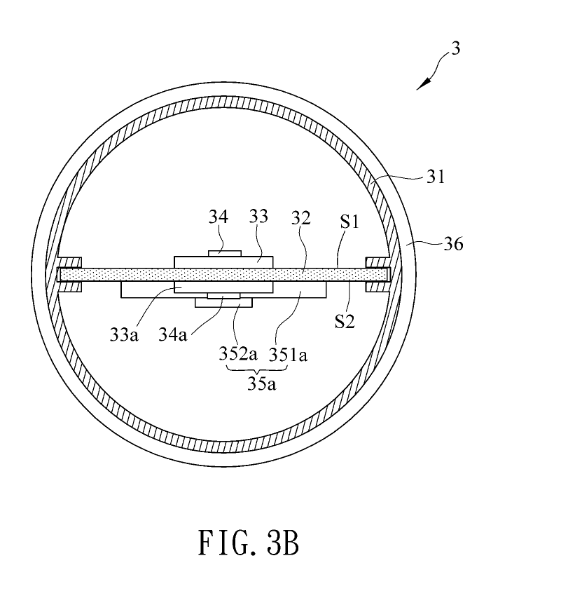

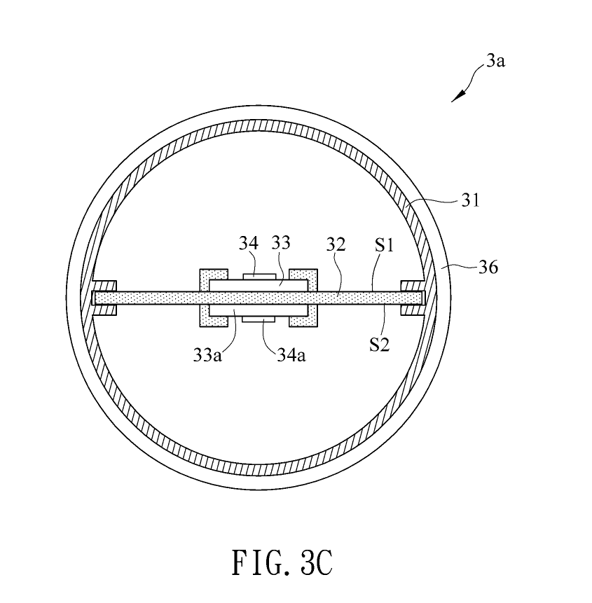

FIG. 3A is an exploded view of a lighting device 3 according to another preferred embodiment of the present invention, and FIG. 3B is a sectional view along line D-D of FIG. 3A.

Different from the lighting device 2 of FIGS. 2A and 2B, the lighting device 3 further includes a second circuit substrate 33a and a plurality of second LEDs 34a. The second circuit substrate 33a is disposed on the second surface S2 of the insulating body 32, and the second LEDs 34a are disposed on and electrically connected with the second circuit substrate 33a.

Besides, the lighting device 3 further includes a second driving module 35a, which includes a circuit board 351a and at least one driving element 352a. The driving element 352a is disposed on the circuit board 351a. The first driving module 35 and the second driving module 35a are disposed on the two sides of the second surface S2 of the insulating body 32, respectively. In this case, the first driving module 35 is electrically connected to the first circuit substrate 33 for driving the first LEDs 34 to emit light, while the second driving module 35a is electrically connected to the second circuit substrate 33a for driving the second LEDs 34a to emit light.

In this embodiment, in order to dispose the second circuit substrate 33a, the first driving module 35 and the second driving module 35a on the second surface S2 of the insulating body 32, the second circuit substrate 33a should be shorter, so that the amount of the second LEDs 34a is less than that of the first LEDs 34.

In practice, it is also possible to dispose the second driving module 35a on the first surface S1 of the insulating body 32. Accordingly, the first driving module 35 and the second driving module 35a may be both disposed on the first surface S1 or the second surface S2, or respectively disposed on first surface S1 and the second surface S2.

In other aspect, when the first driving module 35 and the second driving module 35a are disposed at outside of the tube 31, the length of the second circuit substrate 33a may be the same as that of the first circuit substrate 33, and the number of the first LEDs 34 may be equal to that of the second LEDs 34a. Of course, the numbers of the first LEDs 34 and the second LEDs 34a can be adjusted according to the actual need.

Since the first LEDs 34 and the second LEDs 34a can be disposed on the first surface 51 and the second surface S2, respectively, the lighting device 3 can emit light toward full direction (360°).

FIG. 3C is a sectional view of a lighting device 3a according to another preferred embodiment of the present invention.

Different from the lighting device 3 of FIG. 3B, the first driving module 35 and the second driving module 35a (not shown) of the lighting device 3a are disposed at the outside of the tube 31 and electrically connected to the circuit substrate 33 and 33a, respectively, through wires. In addition, the first circuit substrate 33 is disposed on the first surface 51 of the insulating body 32 by wedging, and the second circuit substrate 33a is disposed on the second surface S2 of the insulating body 32 by wedging. In other aspect, the first circuit substrate 33 can be disposed on the first surface 51 of the insulating body 32 by adhering, and the second circuit substrate 33a is disposed on the second surface S2 of the insulating body 32 by wedging; vice versa. Moreover, the first driving module 35 and the second driving module 35a can be integrated into a single driving unit for driving both the first LEDs 34 and the second LEDs 34a.

The technical features of other components in the lighting devices 3 and 3a are the same as those of the lighting device 2, so the detailed descriptions thereof will be omitted.

In summary, the LEDs are disposed on the circuit substrate and the circuit substrate is disposed on the insulating body. Since the circuit substrate is smaller and lighter, and the lighter insulating body is configured, the weight of the lighting device of the present invention can be sufficiently decreased. In addition, due to the configuration of the insulating body, the lighting device can still have good insulation property without the conventional insulating layer. Moreover, the lighting device of the present invention can select the heat transfer coefficient of the insulating body according to the heat generated by the LEDs. For example, if the LEDs generate heat normally, the insulating body can be made of a material with low heat transfer coefficient. Otherwise, if the LEDs generate extremely large heat, the insulating body can be made of a material with higher heat transfer coefficient.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A lighting device, comprising:
a tube, wherein at least one portion of the tube is light-permeable;
an insulating body disposed in the tube and having a first surface and a second surface, which is opposite to the first surface;
a first circuit substrate disposed on the first surface; and
a plurality of first light emitting diodes disposed on the first circuit substrate and electrically connected with the first circuit substrate.

2. The lighting device according to claim 1, wherein the heat transfer coefficient of the insulating body is between 0.1 and 20 W/mK.

3. The lighting device according to claim 1, wherein the insulating body is a heat-conductive plastic plate.

4. The lighting device according to claim 1, wherein the insulating body comprises a polymer material.

5. The lighting device according to claim 1, wherein the first circuit substrate is a metal substrate.

6. The lighting device according to claim 1, wherein the insulating body and the tube are connected by wedging, adhering, screwing, locking, or thermal fusing.

7. The lighting device according to claim 1, wherein the area of the insulating body is larger than that of the first circuit substrate.

8. The lighting device according to claim 7, further comprising:
a reflective layer disposed on the first surface and surrounding the first circuit board.

9. The lighting device according to claim 7, further comprising:
a light-shielding layer disposed on the first surface and surrounding the first circuit board.

10. The lighting device according to claim 1, further comprising:
a first driving module comprising a circuit board and at least a driving element disposed on the circuit board.

11. The lighting device according to claim 10, wherein the first driving module is connected to the first surface or the second surface of the insulating body.

12. The lighting device according to claim 1, further comprising:
two electronic connecting elements disposed at two ends of the tube.

13. The lighting device according to claim 1, further comprising:
an optical structure disposed on the tube.

14. The lighting device according to claim 1, further comprising:
a second circuit substrate disposed on the second surface; and
a plurality of second light emitting diodes disposed on the second circuit substrate and electrically connected with the second circuit substrate.

15. The lighting device according to claim 10, further comprising:
a second driving module connecting to the first surface or the second surface of the insulating body.

16. The lighting device according to claim 15, wherein the first driving module and/or the second driving module are disposed at the outside of the tube.
